(19) United States
(12) Patent Application Publication
(10) Pub. No.: US 2002/0080719 A1
(43) Pub. Date: Jun. 27, 2002

(54) Scheduling transmission of data over a transmission channel based on signal quality of a receive channel

(76) Inventors: Stefan Parkvall, Stockholm (SE); P?aring;l Frenger, Solna (SE); Erik Dahlman, Bromma (SE)

Correspondence Address: NIXON & VANDERHYE P.C., 8th Floor, 1100 North Glebe Road, Arlington, VA, 22201, US

(21) Appl. No.: 09/742,283

(22) Filed: Dec. 22, 2000

(51) Int. Cl. H04J 1/16

(52) U.S. Cl. 370/235; 370/252

(57) ABSTRACT

Data traffic is selectively transmitted in one direction when the quality or condition of the channel in the opposite direction is sufficient to ensure a reasonable or high likelihood that the transmitter will accurately receive and decode feedback messages. In one preferred, non-limiting, example embodiment, a base station schedules transmission of data packets to a user equipment unit (UE) over a downlink traffic channel when the uplink channel over which the UE sends ARQ type signals to the base station has a signal-to-interference ratio (SIR) greater than a predetermined threshold. The downlink channel condition is also preferably taken into account.

### FIELD OF THE INVENTION

The present invention relates to data communications, and more particularly, to reliable and efficient data delivery in a communications system.

### BACKGROUND AND SUMMARY OF THE INVENTION

In digital data communications systems, it is common for data packets transmitted over a communications channel to be corrupted by errors, e.g., when communicating in hostile environments. Wireless radio communications are often conducted in an especially hostile environment. The radio channel is subjected to a barrage of corrupting factors including noise, rapidly changing communications channel characteristics, multi-path fading, and time dispersion which may cause intersymbol interference, and interference from adjacent channel communications.

There are numerous techniques that may be employed by a receiver to detect such errors. One example of an error detection technique is the well-known Cyclic Redundancy Check (CRC). Other techniques use more advanced types of block codes or convolutional codes to accomplish both error detection and error correction. For both error detection and error correction, channel coding is applied which adds redundancy to the data. When information is received over a communications channel, the received data is decoded using the redundancy to detect if the data has been corrupted by errors. The more redundancy built into a unit of data, the more likely errors can be accurately detected, and in some instances, corrected using a forward error correcting (FEC) scheme. In a pure FEC scheme, the flow of information is unidirectional, and the receiver does not send information back to the transmitter if a packet decoding error occurs.

In many communication systems, including wireless communications, it is desirable to have a reliable data delivery service that guarantees delivery of data units sent from one machine to another without duplication of data or data loss. Most such reliable data delivery protocols use a fundamental retransmission technique where the receiver of the data responds to the sender of the data with acknowledgements and/or negative acknowledgements. This technique is commonly known as Automatic Repeat reQuest (ARQ) transaction processing. Coded data packets are transmitted from a sender to a receiver over a communications channel. Using the error detection bits (the redundancy) included in the coded data packet, each received data packet is processed by the receiver to determine if the data packet was received correctly or corrupted by errors. If the packet was correctly received, the receiver transmits an acknowledgement (ACK) signal back to the sender. In the most simple form of ARQ, sometimes called Stop-and-Wait (S&W) ARQ, the sender of the data stores each sent packet and waits for an acknowledgement of this packet before sending the next packet. When the ACK is received, the sender discards the stored packet and sends the next packet. An example of a Stop-and-Wait ARQ process is shown in FIG. 1. Vertical distance down the figure represents increasing time, and diagonal lines across the middle represent network data transmissions including acknowledgements.

FIG. 2 uses the same format as FIG. 1 to show what happens when a data packet is lost during transmission from sender to receiver. The sender starts a timer after transmitting the packet. If no acknowledgement is received when the timer expires, the sender assumes the packet was lost or corrupted, and retransmits it. The dotted lines show the time that would be taken by the transmission of a packet and its acknowledgement if the packet was not lost or corrupted. If the receiver detects errors in the packet, it may also send an explicit negative acknowledgement (NACK) to the sender. When the NACK is received, the sender can retransmit the packet without waiting for the timer to expire. In addition, if the ACK or NACK is lost on the link from the receiver to the sender, the timer will also expire, and the sender will retransmit the packet.

Stop-and-Wait ARQ decreases throughput because the sender must delay sending a new packet until it receives an acknowledgement for the previous packet. To avoid this problem, a sliding window form of acknowledgement and retransmission may be employed. With a predetermined window of size W, the sender may transmit up to W consecutive packets before an acknowledgement is received. If the sender does not receive an ACK signal for a specific packet within a predetermined time window, or if the sender receives a NACK signal for a specific packet, the sender retransmits either this data packet (selective repeat ARQ) or this packet and all subsequently transmitted packets (go-back-N ARQ). In the example shown in FIGS. 3(a) and 3(b), the window is eight packets in length, and it slides so that packet nine (9) can be sent when an acknowledgement is received for packet one (1).

Because the sliding window ARQ protocol offers the possibility to keep the network saturated with packets, it can achieve substantially higher throughput than a simple Stop-and-Wait protocol. Another example of three packets transmitted using a sliding window ARQ protocol is shown in FIG. 4. The main point illustrated is that the sender can transmit all packets in the window without waiting for an acknowledgement.

Sequence numbers may be assigned to each transmitted data packet. Sequence numbers are used by the sender in an ARQ protocol to identify lost packets and to identify the reception of multiple copies of the same packet. The receiver typically includes the sequence numbers in the acknowledgements, so that acknowledgements can be correctly associated with the corresponding buffered packets.

A special kind of ARQ schemes are so-called Hybrid ARQ schemes, HARQ. In hybrid ARQ (HARC), features of a pure FEC scheme and a pure ARQ scheme are combined. Error correction and error detection functions are performed along with ARQ feedback signaling which typically includes acknowledgment and negative acknowledgment signals, and may also include packet “lost” signals. The channel code or codes in a hybrid ARQ scheme may be used for both error correction and error detection. A negative acknowledgment signal is sent back to the transmitter if an error is detected after error correction. Hybrid ARQ schemes come in two flavors, type 1 and type 2. Whie the erroneously received packet may be discarded, as in HARQ type 1, a more efficient alternative is hybrid ARQ type 2, which save the erroneously received and negatively acknowledged data packet and then combine it in some way with the retransmission. In such a hybrid ARQ combining scheme, the “soft” information from previous, unsuccessful transmission attempts is used in conjunction with the retransmitted packets to improve the probability of decoding a successful packet.

An ARQ protocol may be used to detect errors in decoded packets and request retransmissions of erroneously decoded packets in communications links with wireless user equipment (UE) units over a radio interface. For example, a cellular radio system may provide packet data services to such wireless UEs. Packets of data are transmitted from a radio access network that includes one or more radio network controllers (RNCs) each controlling one or more base stations, to the UEs. An example of such a system is illustrated in block diagram format in FIG. 5. Data packets to be transmitted to a user equipment (UE) unit 3 are provided to the RNC 1 and forwarded to the desired UE over a radio channel by an appropriate base station 2. The UE receives the data packets and determines whether each was correctly received. If not, a retransmission request is sent from the UE to the radio access network. The retransmission requests are handled by the RNC, which resends faulty data packets to the UE through the appropriate base station. In other words, the ARQ protocol extends between the RNC and the UE.

However, there are situations where it is desirable to have an ARQ protocol running between the base station and the UE. For example, data transmission rates can be increased by locating the ARQ retransmission mechanism as close to the radio interface as possible, thereby reducing delays associated with internal signaling in the radio access network, e.g., signaling between the RNC and base station. If the ARQ or HARQ protocol resides in the base station rather than the RNC, the ARQ feedback signaling carrying acknowledgments and/or retransmission requests from a UE terminates much faster in the base station. The BS-RNC signaling load is also decreased.

In addition to having the base station handling retransmissions, it would also be desirable for the base station to schedule downlink data transmissions. When the conditions of a radio channel to a particular UE are favorable, data can be transmitted to the UE at a higher bit rate than if the channel conditions are less favorable. Since packet data traffic typically is not real-time, a base station data transmission scheduler can shift the time in which the downlink data packets are transmitted over the radio channel to correspond with more favorable channel conditions. For a shared radio channel, the base station scheduler would selectively assign the radio channel to one or more UE connections depending upon the quality of the radio channel as detected by each UE. Sharing the radio resources in this fashion means more users can be supported by limited radio resources than if the radio resources were not shared, e.g., dedicated channels are assigned to each UE connection.

While the downlink radio channel quality is particularly relevant for scheduling downlink data packet transmissions, the uplink radio channel conditions is also relevant for scheduling purposes when an (H)ARQ type protocol is used. Indeed, sending data packets on the downlink channel when the uplink radio channel conditions are poor may well mean that ARQ feedback signals from the UE to the base station will be corrupted or even lost as a result of the unfavorable uplink radio channel conditions. Therefore, it is desirable to schedule the downlink radio traffic communication taking into account the uplink channel condition in addition to other scheduling criterions such as the downlink channel quality. If the uplink channel condition is unfavorable, the base station scheduler should postpone the downlink transmission until the uplink radio channel condition becomes more favorable.

Considering uplink radio channel conditions is particularly important for example in Wideband Code Division Multiple Access (WCDMA) systems that employ stringent power control requirements on the transmitters. For example, the uplink transmit power of each UE is continuously adjusted by the base station transmitting power control commands to the UE so that the quality of the received UE signal is sufficiently high. If the received signal from a UE is at a higher power than necessary, the base station sends a “down” command to the UE. Alternatively, if the received power is too low for successful reception of the UE signal at the base station, an “up” command is sent to the UE. Thus, the transmitted power from the UE is kept as low as possible while still maintaining the quality of the uplink data transmission.

In some scenarios, such as when the UE is located close to the border between two cells, the same uplink data transmission from the UE is received by two or more base stations. This situation is referred to as “soft” handover. Each of the base stations tries to decode the received data and forward it to the RNC together with an indication whether the received data is in error. The RNC selects the base station having correctly decoded the data, and forwards the correctly decoded data to an external network, while discarding the corresponding data packets from the other base stations. For soft handover power control, if any of the base stations involved in the soft handover issues a “power down” command to a UE, that UE lowers its transmitted power. If all base stations issue a “power up” command, the UE increases its power. Using this power control scheme, at least one base station, (i.e., the one issuing the power down command), should be able to decode the uplink transmission from the UE. That decoded uplink packet transmission should be of sufficient signal strength/quality to be selected by the RNC.

ARQ protocols perform well as long as the ARQ feedback signals reach the entity handling the ARQ protocol. If the ARQ protocol is located in the RNC, soft handover is not a problem because different uplink ARQ feedback signals are all received by the RNC. On the other hand, if the ARQ protocol is located in the base station, soft handover creates problems because there is no guarantee that ARQ feedback signals will reach the specific base station actually handling the downlink transmission.

Consider the example soft handover situation shown in FIG. 5. UE 3 is in an uplink soft handover with base station 1 and base station 2. The downlink data (solid line) is transmitted to UE 3 from only base station 1. The ARQ protocol for this downlink data communication with UE 3 resides in base station 1. Consider the situation where the condition of the uplink channel to base station 2 becomes more favorable than that of the uplink channel to base station 1. Base station 2 sends a power down command to UE 3. As a result, UE 3 reduces its transmit power to a level where the uplink ARQ feedback signaling can be accurately decoded at base station 2, but not at base station 1. Indeed, if the uplink ARQ signaling from UE 3 does not reach base station 1, base station 1 has no idea whether the downlink packets transmitted to UE 3 were successfully received and/or successfully decoded. If the base station 1 assumes that no ARQ feedback means a successful data packet transfer, this is a problem when the transfer has not been successful. On the other hand, if the base station automatically retransmits the packet when no ARQ signaling message is received in the uplink, a large number of unnecessary retransmissions may be scheduled simply because there has been no ARQ feedback signal received for successfully decoded packets.

Since it is desirable for the base station to control the ARQ protocol for the reasons mentioned above, a reliable ARQ feedback signaling in the base station is necessary to overcome the problems noted above. One possible solution is to transmit ARQ feedback signals from the UE at a substantially higher power than other uplink traffic transmitted by the UE. Unfortunately, this approach generates high levels of undesirable uplink interference. In addition, a separate or more complex power amplifier might be required in the UE to handle significantly different transmit powers.

Another possible solution would be to prohibit uplink soft handover, or prevent uplink soft handover for the portion of the uplink channel carrying ARQ feedback signaling. Prohibiting all uplink channels from soft handover comes at the price of reduced performance, which is a major benefit of soft handover. Moreover, allowing uplink soft handover for signals other than the ARQ feedback signals requires two separate power control commands for each UE: one command for the uplink channel in soft handover and one command for the uplink channel that is not in soft handover. This approach is undesirable because it requires a redesign of existing downlink signaling protocols. It is also cumbersome for the base station to make separate power control measurements for different uplink channels, especially if the ARQ feedback traffic is bursty in nature.

A third possible solution is to combine the ARQ feedback signals in the RNC and have the RNC inform the base station handling the ARQ protocol whether a downlink data packet was successfully transferred. However, this additional RNC-base station signaling would create significant delays.

The solution presented by the present invention is to selectively transmit traffic in over a channel in one direction, (e.g., downlink), when a channel in the opposite direction, (e.g., uplink), is of sufficient quality to assure a reasonable or high likelihood that the transmitter will accurately receive and decode feedback or other messages, (e.g., ARQ messages). A general method in accordance with the present invention can be applied to any data communication system where data packets are transmitted from a first node over a first channel to a second node and a feedback or other control signal is sent back to the first node from the second node over a second channel. The first node determines the condition of the second channel. Based on that determined condition of the second channel, the first node controls transmission of data packets over the first channel. In addition to considering the condition of the second channel, it may be a desirable to also consider the condition of the first channel. In this way, the first node could control transmission of data packets over the first channel based on the condition of both the first and second channels. Other conditions could be considered as well in the control of the data transmission over the first channel.

That transmission control may include scheduling when and/or how many data packets are transmitted over the first channel. In particular, the first node may delay transmission of data packets over the first channel until the quality of the second channel exceeds its predetermined threshold, e.g., a predetermined signal-to-interference ratio (SIR). It may be a desirable option to ultimately transmit the data packets after a preset delay period expires, even if the second channel quality has not improved to exceed the predetermined threshold.

The first node determines whether the condition of the second channel is sufficient to assume that the first node will probably accurately receive a feedback signal from the second node. In addition to an acceptable SIR as a measure of that sufficiency, other examples include an error rate or a probability of error in the received feedback signal, or the frame error probability of information sent through the same channel as the feedback information. Examples of feedback signals include an acknowledge signal, a negative acknowledge signal, and/or a lost signal corresponding to a data packet transmitted over the first channel.

In a preferred example embodiment, the first node is a base station in a radio communications network, and the second node is a wireless user equipment unit. Accordingly, the first channel is a downlink radio channel, and the second channel is an uplink radio channel. However, the present invention may be applied to other nodes. For example, the first node could be a wireless user equipment unit and the second node a base station. Still further, the first node could be an RNC controller coupled to one or more base stations, and the second node a wireless user equipment unit.

Returning to the preferred, example (and non-limiting) embodiment, the base station includes a first detector that determines a signal quality of an uplink channel from the wireless user equipment to the base station. A data packet scheduler in the base station schedules transmission of data packets over a dowrlink channel from the base station to the wireless user equipment taking into account the determined quality of the uplink channel, along with any other scheduling criterions. The base station may also include a second detector that determines a signal quality of the downlink channel. The scheduler then may schedule transmission of data packets over the downlink channel based on the determined signal quality of both the uplink and downlink radio channels.

An automatic repeat request (ARQ) protocol for the downlink communication to the UE is handled in the base station. The condition of the uplink channel must be good enough for the base station to accurately receive an ARQ feedback signal from the wireless user equipment. For a lower quality uplink channel condition, the scheduler may delay transmission of data packets to a certain user over the downlink channel and assign the shared downlink channel to another user until the quality or condition of the uplink channel exceeds a predetermined threshold, e.g., a bit error rate, a signal-to-interference ratio, etc. There may also be a third detector in the base station that detects a predetermined condition, which although unrelated to uplink channel quality, preempts the scheduling decision being based on uplink channel quality. For example, the detected condition may be when a Doppler frequency of the uplink channel exceeds a threshold. Another example of such a condition is when the load of a cell corresponding to the base station is less than the threshold.

### BRIEF DESCRIPTION OF THE DRAWINGS

The foregoing and other objects, features, and advantages of the invention will be apparent from the following description of preferred, non-limiting example embodiments, as well as illustrated in the accompanying drawings. The drawings are not to scale, emphasis instead being placed upon illustrating the principles of the invention.

FIG. 1 is a signaling diagram illustrating an acknowledgment with retransmission data delivery protocol;

FIG. 2 is a diagram of the acknowledgment with retransmission data delivery protocol employed when a data packet is lost or corrupted;

FIGS. 3(a) and 3(b) illustrate a sliding window technique;

FIG. 4 shows an example of a sliding window ARQ protocol;

FIG. 5 is a function block diagram of a radio communications system in which the present invention may be employed;

FIG. 6 illustrates another context where the present invention may be employed;

FIG. 7 is a flowchart diagram illustrating a data packet scheduling routine in accordance with one aspect of the present invention;

FIG. 8 is a flowchart diagram illustrating example application of the present invention to scheduling downlink data transmissions;

FIG. 9 is a diagram of a Universal Mobile Telephone System (UMTS) in which the present invention may be advantageously employed;

FIG. 10 is a function block diagram of a base station from FIG. 9 in which the present invention may be employed; and

FIG. 11 is a function block diagram of a user equipment unit from FIG. 9 in which the present invention may be employed.

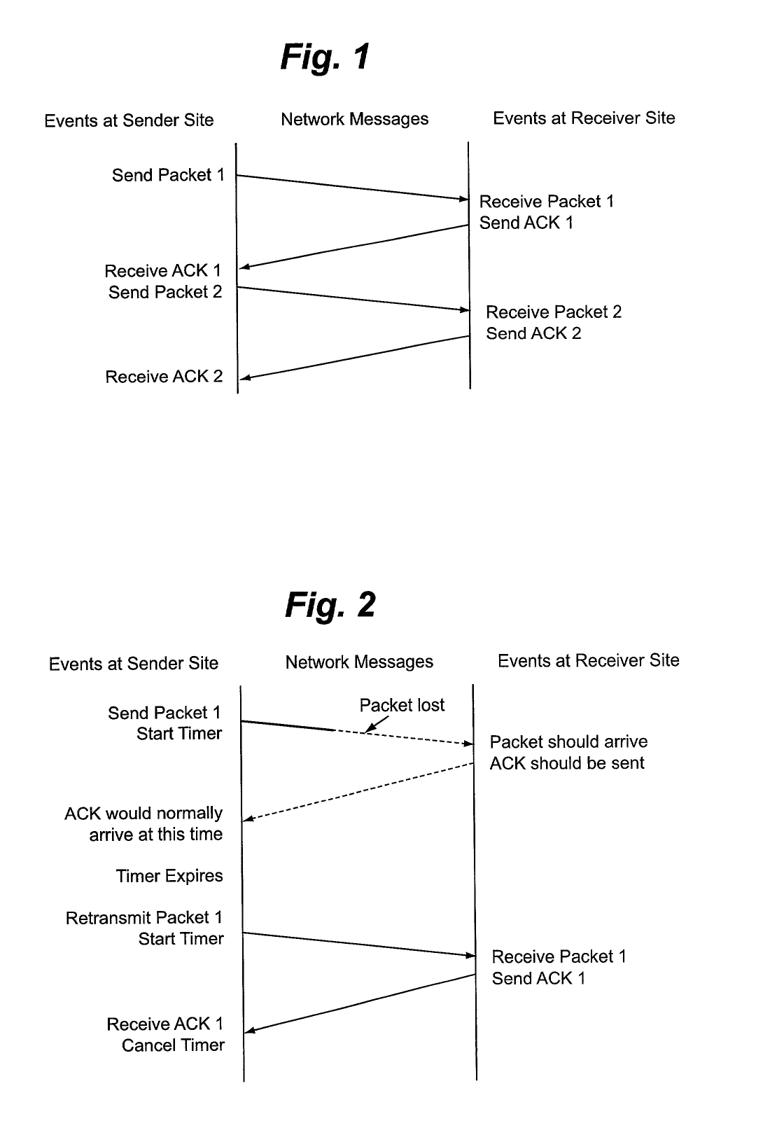

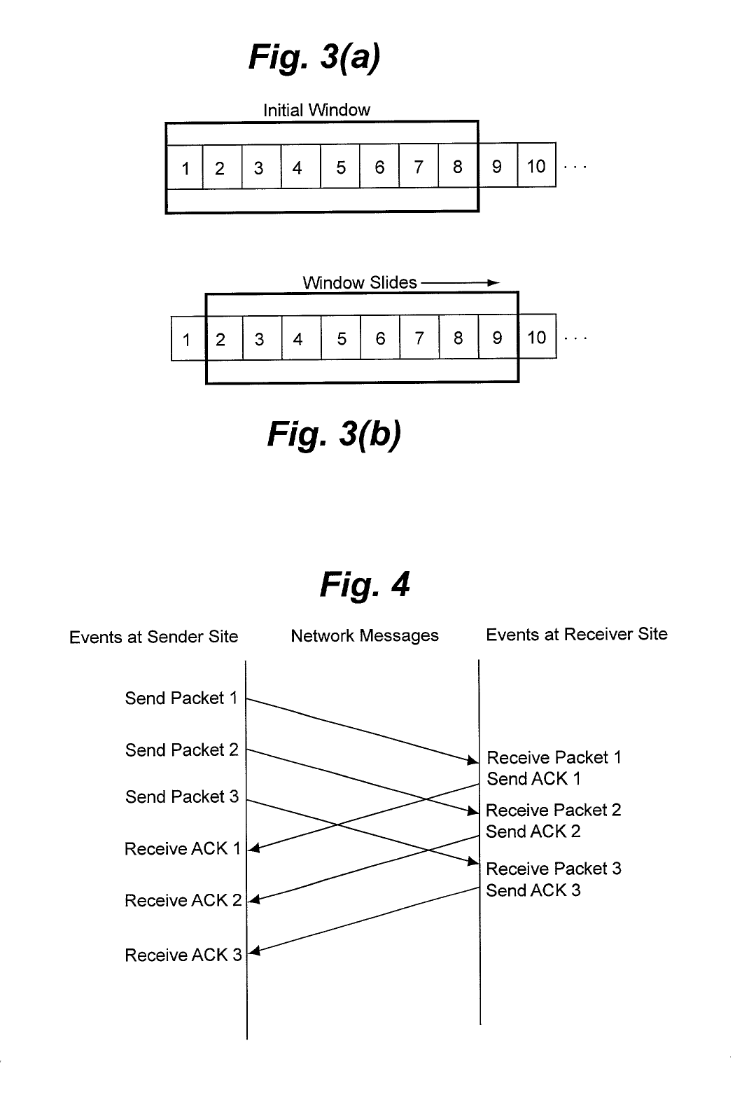

### DETAILED DESCRIPTION OF THE DRAWINGS

In the following description, for purposes of explanation and not limitation, specific details are set forth, such as particular embodiments, procedures, techniques, etc., in order to provide a thorough understanding of the present invention. However, it will be apparent to one skilled in the art that the present invention may be practiced in other embodiments that depart from these specific details. For example, the following description is in the context of a downlink example from the radio network to the wireless user equipment. Those skilled in the art will appreciate that the present invention may also be implemented in the opposite, uplink direction. In some instances, detailed descriptions of well-known methods, interfaces, devices and signaling techniques are omitted so as not to obscure the description of the present invention with unnecessary detail. Moreover, individual function blocks are shown in some of the figures. Those skilled in the art will appreciate that the functions may be implemented using individual hardware circuits, using software functioning in conjunction with a suitably programmed digital microprocessor or general purpose computer, using an Application Specific Integrated Circuit (ASIC), and/or using one or more Digital Signal Processors (DSPs).

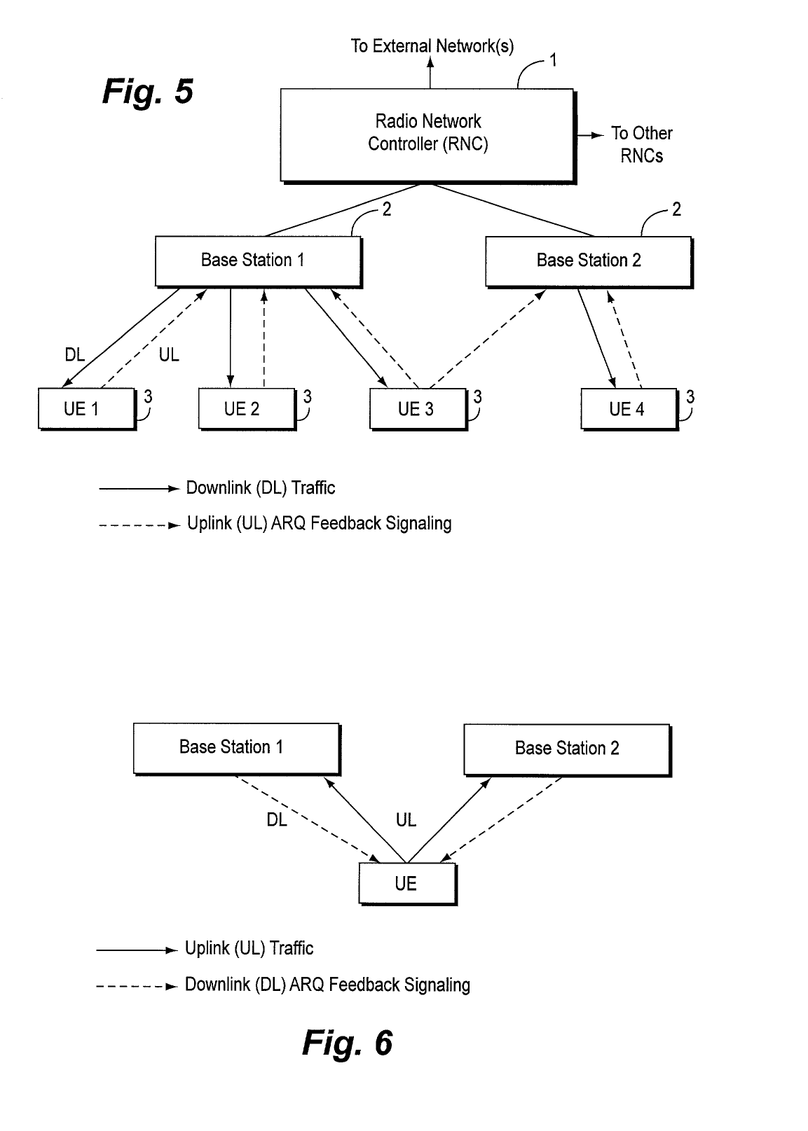

The present invention selectively transmits data traffic over a channel in one direction when, the quality or condition of the channel in the opposite direction is sufficiently good to ensure a reasonable or high likelihood (depending on system objectives) that the transmitter will accurately receive and decode feedback or other messages from the receiver. Typically, the quality of the channel in the one direction, and perhaps other criteria, are also considered. Two non-limiting, example, downlink applications of the present invention will now be described in the context of the communications environment shown in FIG. 5.

In the first, preferred, example downlink implementation, the ARQ protocol is located and operated in the base station that is transmitting downlink data traffic to a user equipment unit 3. As described above, performing ARQ operations and data transmission scheduling operations in the base station provides significant advantages, including reduced amounts of signaling and delays pertaining to the ARQ protocol in the radio access network, as well as increased data transmission capacity and efficiency. However, in order to ensure proper operation of the ARQ protocol, it is important that the ARQ feedback signals from the UE, such as acknowledge, negative acknowledge, and/or lost, be accurately received and decoded in the transmitting base station. Accordingly, the transmitting base station node determines the condition of the uplink channel. Based on the condition of the uplink channel, the base station schedules transmission of data packets over the downlink channel to the user equipment. In general, the base station delays transmission of the data packets over the downlink channel to the user equipment until there is a sufficient probability that an ARQ feedback signal (or other feedback signal) will be received in the base station. Of course, one or more other criteria may be taken in account. Moreover, during the transmit delay for one UE, the base station should preferably transmit data to another UE having a better quality channel.

Sufficiency may be determined based on a bit error rate or a signal-to-interference ratio (SIR) associated with the uplink channel. Other measures could be used. Because conditions change so rapidly in a mobile radio communications system, it is likely that a low quality uplink channel will improve to a sufficient quality channel in a short time period. However, it may be advisable to set a delay period after which data packets are transmitted to the user equipment irrespective of the condition of the uplink channel. Otherwise, downlink data packets might, in some cases, encounter large delays.

By taking into account the quality of the uplink channel from the user equipment, the transmitting base station ensures that it receives ARQ or other similar feedback signals. This is particularly important if the user equipment is in soft handover. Even if another base station, such as base station 2, which is not transmitting the downlink data to the user equipment, momentarily happens to have a better uplink channel than base station 1, base station 1 ensures that it will receive any feedback signal by controlling the timing of the downlink transmission.

In a preferred example implementation, the base station determines a signal quality of the downlink channel and base its scheduling decision on both of the uplink and downlink channel conditions. In addition, there may be certain situations or conditions in which it is unnecessary or undesirable to schedule the downlink data transmission based upon the uplink signal channel quality. For example, a wireless user equipment may be moving with such speed (for example in an automobile) that it is difficult to predict the quality of the uplink channel. In this, and other types of unpredictable situations, it may make sense to transmit data over the downlink channel regardless of the instantaneous uplink channel quality estimate. One way to detect this condition is to detect whether the uplink Doppler frequency from the UE is above a certain level. At lower doppler frequencies, the prediction of the uplink channel quality is more likely to be reliable and useful.

Another situation in which the consideration of the uplink signal quality may be less relevant and/or desirable is when the traffic load is relatively light. If the base station detects that the traffic condition in the UE's current cell is below a particular threshold level indicating a lower interference level, there is a higher likelihood that uplink signals will be received and accurately decoded by the base station. Moreover, excess retransmissions caused by the failure to receive uplink ARQ feedback signaling should not significantly degrade performance because of the light loading. On the other hand, if the cell is heavily loaded, unnecessary retransmissions may significantly degrade the service to other users in the system, and the present invention may be particularly advantageous.

Another condition in which the consideration of uplink signal quality may be less relevant and/or desirable would be when the rate at which the uplink channel is rapidly varying. For rapidly varying feedback channels, the uplink channel quality consideration may be of less use because the SIR or other measurement data is outdated by the time it is received by the base station. In this case, there is less benefit to be obtain with scheduling data transmission based uplink signal quality than for a slower varying feedback channel.

While bit error rate, signal-to-interference, signal-to-noise ratio measurements, etc. are reasonable estimates for uplink channel quality, (these estimates are particularly attractive since they are usually already measured and available from other procedures in existing mobile radio communication systems), there are other ways in which the uplink signal quality could be indicated to the base station. For example, certain cellular systems employ a fast cell selection (FCS) technique in which the user equipment selects on a frame-by-frame basis which base station cell will transmit the next frame of information to the user equipment. Some cellular systems also use modulation and coding schemes (MCS) in which the user equipment sends a message to a base station selecting a particular type of modulation and/or coding for the downlink transmission. Thus, the FCS and MCS signaling from the UE, or any other UE report expected to be received at a regular and frequent basis, could be used as a direct or indirect indication of uplink channel quality. For example, if such expected uplink signals like FCS or MCS signals are not received when expected, this indicates an insufficient or poor uplink signal quality. Of course, these approaches assume that FCS, MCS, or other signals are sent at a sufficiently high rate.

Although less desirable, the present invention could also be implemented in the radio network controller. In other words, the RNC collects information about the uplink channel and controls the timing of downlink transmission to the user equipment via one or more base stations based upon the uplink signal quality condition. Of course, the disadvantage with having the radio network controller make that decision is the signal delay between the base station and radio network controller. Such delays are particularly problematic for a changing uplink channel.

Another example application of the present invention is to uplink traffic transmissions from a user equipment to one or more base stations. FIG. 6 illustrates such a situation where uplink traffic is transmitted from the UE to base stations 1 and 2, and base stations 1 and 2 provide downlink ARQ feedback signals to the UE. In this case, the UE detects the condition of the downlink channel and schedules uplink data transmissions based upon the quality of that downlink channel. The UE may postpone its uplink data transmission until it is sure that it can receive ARQ feedback signals sent over the downlink channel from one or more of the base stations.

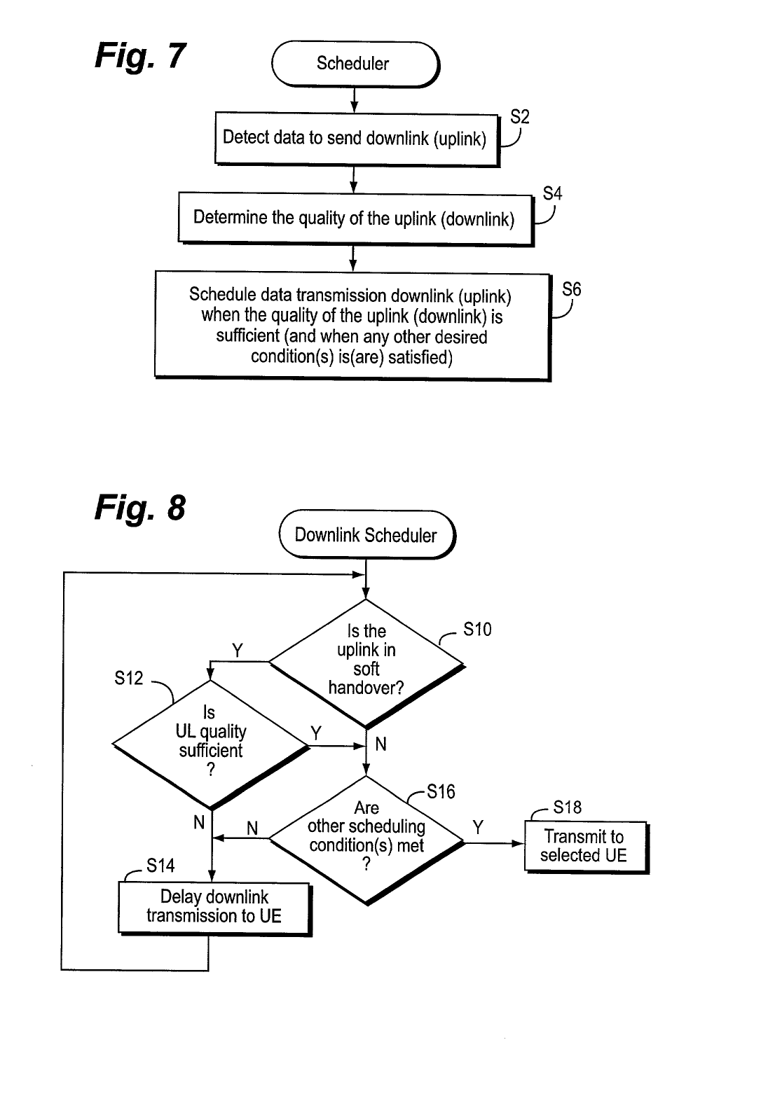

Reference is now made to the flowchart diagram of FIG. 7 illustrating scheduling procedures in accordance with a general embodiment of the present invention. Initially, data is detected in a transmitting node to be sent downlink (or uplink) (step S2). The transmitting node determines the quality of the uplink channel (or downlink channel) (step S4). The transmitting node then schedules the data transmission over the downlink channel (or the uplink channel) when the quality of the uplink channel (or the downlink channel) is sufficient (step S6).

Additional, optional scheduling procedures for dowlink data transmissions are illustrated in flowchart format in FIG. 8 where other optional factors are taken into consideration in addition to the quality of the uplink channel. A decision may be made in optional step S10 whether the uplink communication from the UE is in soft handover. If the uplink is in soft handover or in any event, a decision is made in step S12 to determine whether the uplink channel quality is sufficient. If it is not, downlink data transmission to the UE is delayed (step S14). If the uplink signal quality is sufficient or the uplink is not in soft handover, one or more other scheduling conditions may be checked (step S16). If those one or more other scheduling conditions are met, the data can be transmitted downlink to the UE (step S18). Otherwise, downlink data transmission to the UE is delayed.

In the previously described scheme, downlink data is not scheduled for transmission unless the uplink channel quality is sufficient to receive feedback signaling with a predetermined probability. Thus, downlink transmission capacity is not wasted on downlink transmissions that will result in retransmissions regardless of whether the downlink data packets are properly decoded. Instead, the radio resources can be provided to another downlink user with data to transmit. This allows the downlink channel to be utilized in an efficient manner that avoids unnecessary retransmissions. Avoiding unnecessary retransmissions reduces interference generated if there are no users with data waiting for transmission.

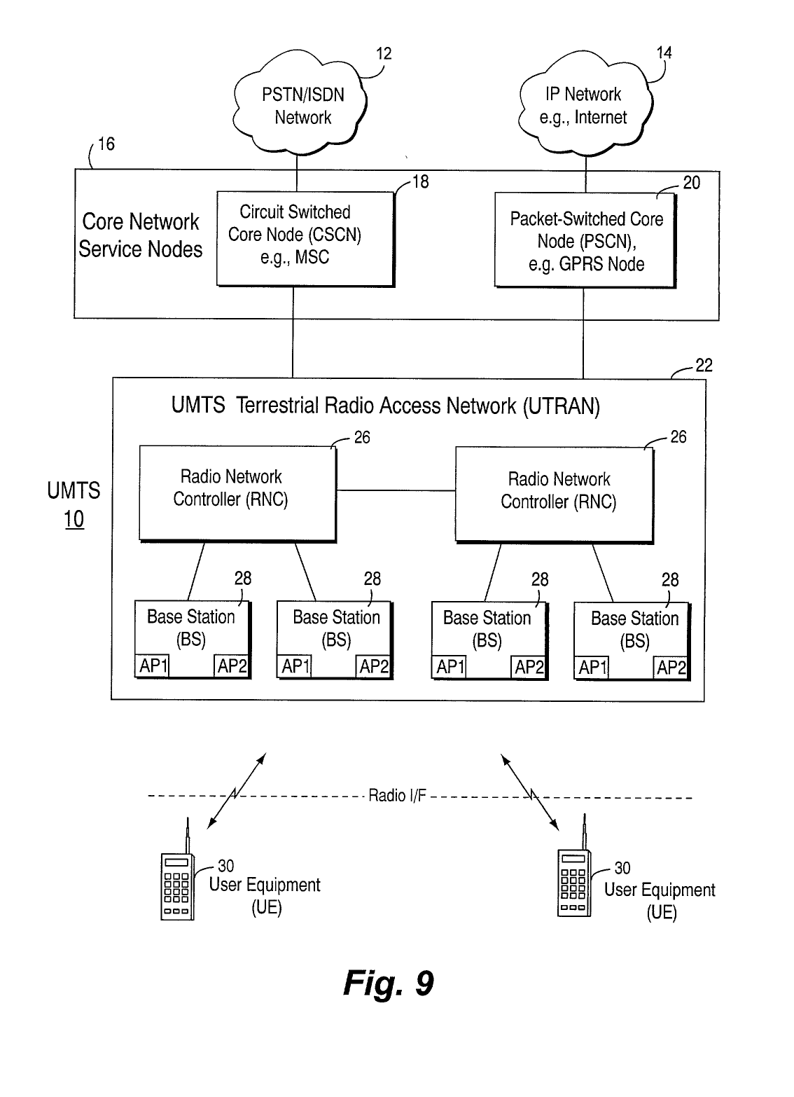

The present invention finds particular (although not limiting) application to a Universal Mobile Telecommunications System (UMTS) such as that shown at reference numeral 10 in FIG. 9. A representative, circuit-switched core network, shown as cloud 12, may be for example the Public Switched Telephone Network (PSTN) or the Integrated Services Digital Network (ISDN). A representative, packet-switched core network, shown as cloud 14, may be for example an IP network like the Internet. Both core networks are coupled to corresponding core network service nodes 16. The PSTN/ISDN circuit-switched network 12 is connected to a circuit-switched service node shown as a Mobile Switching Center (MSC) 18 that provides circuit-switched services. The packet-switched network 14 is connected to a General Packet Radio Service (GPRS) node 20 tailored to provide packet-switched type services.

Each of the core network service nodes 18 and 20 connects to a UMTS Terrestrial Radio Access Network (UTRAN) 22 that includes one or more Radio Network Controllers (RNCs) 26. Each RNC is connected to a plurality of Base Stations (BSs) 28 and to other RNCs in the UTRAN 22. Each base station 28 corresponds to one access point (one sector or cell) or includes plural access points. Radio communications between one or more base station access points and a wireless user equipment unit (UE) are byway of a radio interface. Radio access in this non-limiting example is based on Wideband-CDMA (W-CDMA) with individual radio channels distinguished using spreading codes. Wideband-CDMA provides wide radio bandwidth for multi-media services including packet data applications that have high data rate/bandwidth requirements. One scenario in which high speed data may need to be transmitted downlink from the UTRAN over the radio interface to a UE is when the UE requests information from a computer attached to the Internet, e.g., a website.

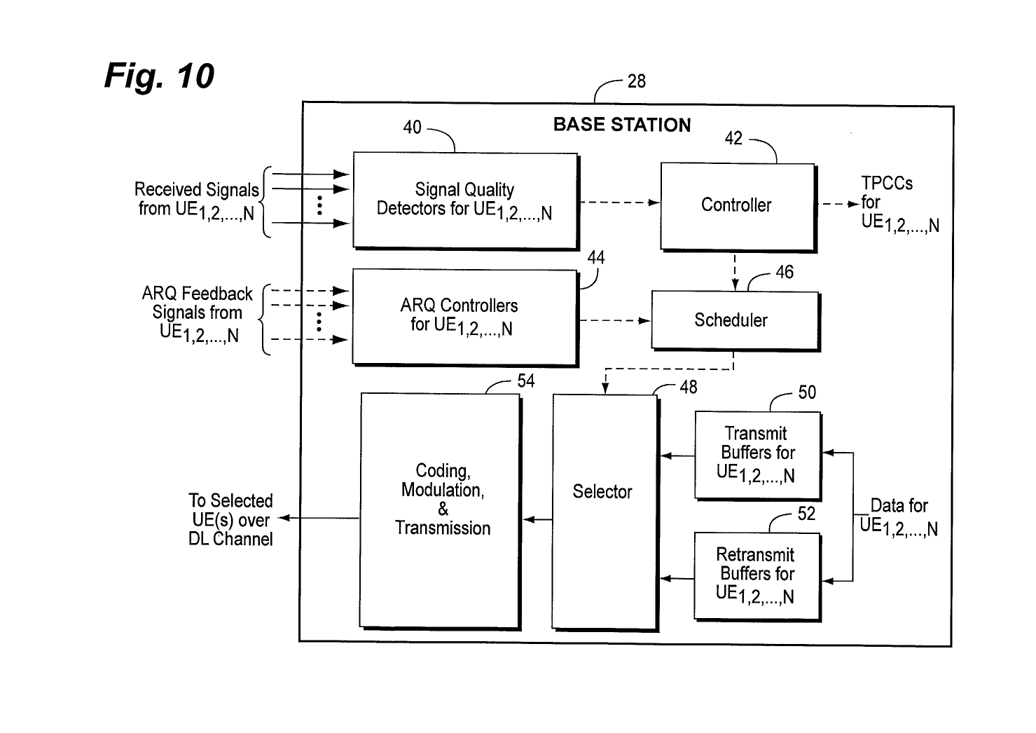

FIG. 10 shows modules, e.g., hardware and/or software modules, that may be used to implement the present invention in an example downlink data transmission scenario in the UMTS system of FIG. 9 from a base station to a UE. Signal quality detectors 40 detect the signal quality of signals received from each of plural user equipment units (UE_{1,2, . . . N}). Preferably, the uplink signal channel quality is determined by measuring a received uplink signal-to-noise ratio (SIR) for each UE. These SIR measurements are typically already made for power control purposes. The signal qualities for received signals from the user equipment units are provided to a controller 42 which generates transmit power control commands (TPCCs) sent to UEs_{1, 2, . . . N} to regulate the transmit power levels based upon the received signal quality measurements. Those signal quality measurements for the uplink channels from the UEs are also provided by controller 42 to a scheduler 46. Based upon the signal quality of the uplink channels, and other criteria such as the signal quality of the downlink channel for a particular user, scheduler 46 provides a control signal to selector 48.

One or more ARQ controllers 44 for each of the active connections with UE_{1, 2, . . . N} receives ARQ feedback signals from UEs_{1, 2, . . . N.} These feedback signals may include, for example, one or more of an acknowledgment signal, a negative acknowledgment signal, and a lost signal for each packet transmitted by the base station to the UE. The ARQ feedback signals are also provided to the scheduler 46.

Transmit buffers 50 and retransmit buffers 52 store data packets to be transmitted or already transmitted to the UE_{1, 2, . . . N.} Data from a transmit buffer 50 is delayed by selector 48, which is controlled by scheduler 46, until the signal quality on the UE's uplink channel is of sufficient quality, and typically, one or more other scheduling criteria are met. Upon selection via selector 48, data packets from the transmission buffers 50 are processed in signal processing module 54 and transmitted over one or more downlink channels to selected UEs. This signal processing module may perform various operations such as coding (in addition to any ARQ-related coding), modulation, and RF transmission. If the scheduler 46 receives a negative or lost signal from the ARQ controller 44 or fails to receive an acknowledgment signal for the ARQ controller within a predetermined time window for a particular packet, it sends a signal to selector 48 to retransmit that packet from the appropriate retransmit buffer 52 via coding modulation and transmission block 54 when the uplink channel condition is sufficiently good.

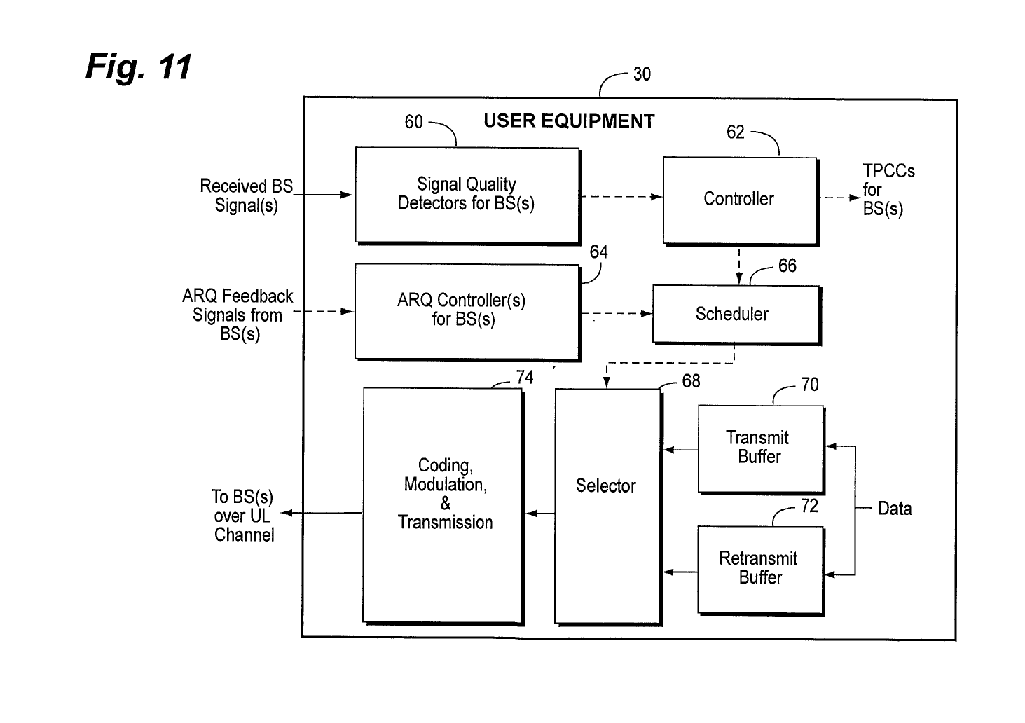

FIG. 11 shows a function block diagram of a user equipment 30 from FIG. 9 for another example implementation of the present invention in the opposite transmission direction, i.e., uplink data transmission. The user equipment has one or more signal quality detectors 60 for detecting the signal quality of signals received from one or more base stations. Typically, this type of detector is already in operation for downlink power control operations. The signal quality information is forwarded to controller 62 which sends appropriate transmit power control commands (TPCCs) back to the transmitting base station(s). That signal quality information is also forwarded by the controller 62 to a data packet scheduler 66. ARQ feedback signals from receiving base stations are handled by one or more ARQ controllers 64 which forwards the ARQ feedback signals from the base station(s) the scheduler 66. Data to be transmitted from the user equipment to the base station(s) is stored in transmit buffer 70 and retransmit buffer 72. A control signal from scheduler 66 is provided to selector 68 which determines from which buffer 70 and 72 data packets will be selected and the time for transmission by way of coding modulation and transmission block 74 over the uplink channel to one or more base stations. If the signal quality on the dowlink is below a predetermined signal to interference ratio or other signal quality threshold, the scheduler 66 delays (via selector 68) transmission of the data packet until the signal quality improves. If a packet needs to be retransmitted from retransmitted buffer 72, similar scheduling of that retransmission also occurs.

While the present invention has been described with respect to particular example embodiments, those skilled in the art will recognize that the present invention is not limited to those specific embodiments described and illustrated herein. Different formats, embodiments, adaptations besides those shown and described, as well as many modifications, variations and equivalent arrangements may also be used to implement the invention. For example, although a preferred embodiment relates to a downlink application, the present invention may also be used in uplink and other downlink applications. Therefore, while the present invention is described in relation to a preferred example embodiment, it is to be understood that this disclosure is only illustrative and exemplary of the present invention. Accordingly, it is intended that the invention be limited only by the scope of the claims appended hereto.

What is claimed is:

1. In a system where data packets are communicated from a first node over a first channel to a second node and a feedback signal is sent back to the first node from the second node over a second channel, a method comprising:
the first node determining a condition of the second channel, and
based on the determined condition of the second channel, the first node controlling transmission of data packets over the first channel.

2. The method in claim 1, wherein the first node schedules the transmission of data packets over the first channel based on the determined condition of the second channel.

3. The method in claim 1, further comprising:
the first node determining a condition of the first channel, and
based on the determined condition of the first and second channels, the first node controlling transmission of data packets over the first channel.

4. The method in claim 1, further comprising:
the first node determining whether the condition of the second channel is sufficient for the first node to accurately receive a feedback signal from the second node.

5. The method in claim 3, wherein the sufficiency of the condition of the second channel is determined so that a probability of error in the received feedback signal is below an error threshold.

6. The method in claim 1, wherein the feedback signal is an acknowledge signal, a negative acknowledge signal, or a lost signal corresponding to a data packet transmitted over the first channel.

7. The method in claim 1, further comprising:
the first node delaying transmission of data packets over the first channel until the quality of the second channel exceeds a predetermined threshold.

8. The method in claim 7, wherein the predetermined threshold is a signal-to-interference ratio (SIR).

9. The method in claim 7, further comprising:
transmitting the data packets after a preset delay period expires.

10. The method in claim 1, wherein the first node is a base station in a radio communications network and the second node is a wireless user equipment unit, and wherein the first channel is a downlink radio channel and the second channel is an uplink radio channel.

11. The method in claim 1, wherein the first node is a wireless user equipment unit in a radio communications network and the second node is a base station, and wherein the first channel is an uplink radio channel and the second channel is a downlink radio channel.

12. The method in claim 1, wherein the first node is a radio network controller coupled to one or more base stations in a radio communications network and the second node is a wireless user equipment unit.

13. The method in claim 1, further comprising:
detecting another condition, and
controlling the data packet transmission over the first channel without regard to the condition of the second channel when the other condition is detected.

14. In a mobile communications system where data packets are communicated between one or more base stations and wireless user equipment units over a radio interface, a method implemented in one of the base stations, comprising:
determining a signal quality of an uplink channel from the wireless user equipment to the base station, and
scheduling transmission of data packets over a downlink channel from the base station to the wireless user equipment taking into on the determined quality of the uplink channel.

15. The method in claim 14, wherein the signal quality is a signal-to-interference ratio (SIR).

16. The method in claim 14, further comprising:
determining a signal quality of the downlink channel, and
based on the determined signal quality of the uplink and downlink channels, scheduling transmission of data packets over the downlink channel.

17. The method in claim 14, wherein the base station employs an automatic repeat request (ARQ) protocol to provide reliable data packet communications with the wireless user equipment, the method further comprising:
determining whether the signal quality of the uplink channel is sufficient for the base station to accurately receive an ARQ feedback signal from the wireless user equipment.

18. The method in claim 17, wherein the sufficiency of the signal quality of uplink channel is determined so that a probability of error in the received ARQ feedback signal is below a threshold.

19. The method in claim 17, wherein the feedback signal is an acknowledge (ACK) signal, a negative acknowledge (NACK) signal, or a lost signal corresponding to a data packet transmitted over the first channel.

20. The method in claim 14, wherein the scheduling further comprises:
delaying transmission of data packets over the downlink channel until the quality of the uplink channel exceeds a predetermined threshold.

21. The method in claim 20, further comprising:
transmitting the data packets after a preset delay period expires.

22. The method in claim 14, wherein the wireless user equipment is communicating with two base stations in a soft handover communication.

23. The method in claim 14, further comprising:
detecting a predetermined condition, and
scheduling the downlink data packet transmission without regard to the uplink channel signal quality when the predetermined condition is detected.

24. The method in claim 23, wherein the detected condition is when a Doppler frequency of the uplink channel exceeds a threshold.

25. The method in claim 23, wherein the detected condition is when a load of a cell corresponding to the base station is less than a threshold.

26. A first communications unit for communicating data packets over a first channel to a second communications unit, where the second communications unit sends a feedback signal to the first communications unit over a second channel, the first communications unit comprising:
a detector capable of determining a condition of the second channel, and
a controller capable of controlling transmission of data packets over the first channel based on the determined condition of the second channel.

27. The communications unit in claim 26, wherein the controller includes a scheduler capable of scheduling transmission of data packets over the first channel based on the determined condition of the second channel.

28. The communications unit in claim 26, further comprising:
a detector capable of determining a condition of the first channel,
wherein the controller is capable of scheduling transmission of data packets over the first channel based on the determined conditions of the first and second channels.

29. The communications unit in claim 26, wherein the scheduler is capable of delaying transmission of data packets over the first channel until the quality of the second channel exceeds a predetermined threshold.

30. The communications unit in claim 29, wherein the predetermined threshold is a signal-to-interference ratio (SIR).

31. The communications unit in claim 26, wherein the controller is capable of determining whether the condition of the second channel is sufficient for the first communications unit to accurately receive a feedback signal from the second communications unit.

32. The communications unit in claim 31, wherein the sufficiency of the condition of the second channel is determined so that a probability of error in the received feedback signal is below a threshold.

33. The communications unit in claim 26, wherein the feedback signal is an acknowledge signal, a negative acknowledge signal, or a lost signal corresponding to a data packet transmitted over the first channel.

34. The communications unit in claim 26, wherein the first communications unit is a base station in a radio communications network and the second communications unit is a wireless user equipment unit, and wherein the first channel is a downlink radio channel and the second channel is an uplink radio channel.

35. The communications unit in claim 26, wherein the first communications unit is a wireless user equipment unit in a radio communications network and the second communications unit is a base station, and wherein the first channel is an uplink radio channel and the second channel is a downlink radio channel.

36. The communications unit in claim 26, wherein the first communications unit is a radio network controller coupled to one or more base stations in a radio communications network and the second communications unit is a wireless user equipment unit.

37. The communications unit in claim 26, further comprising:
another detector capable of detecting another condition,
wherein the controller is capable of controlling the data packet transmission over the first channel without regard to the condition of the second channel when the other condition is detected.

38. A mobile radio communications system incorporating the communications unit of claim 26.

39. A mobile communications system, comprising:
one or more base stations;
wireless user equipment units communicating data packets with one or more base stations over a radio interface,
wherein each base station includes:
a first detector configured to determine a signal quality of an uplink channel from the wireless user equipment to the base station, and
a data packet scheduler configured to schedule transmission of data packets over a downlink channel from the base station to the wireless user equipment taking into account the determined quality of the uplink channel.

40. The mobile communications system in claim 39, wherein the signal quality is a signal-to-interference ratio (SIR).

41. The mobile communications system in claim 39, the base station further including:
a second detector configured to determine a signal quality of the downlink channel,
wherein based on the determined signal quality of the uplink and downlink channels, the scheduler is configured to schedule transmission of data packets over the downlink channel.

42. The mobile communications system in claim 39, wherein the one base station is configured to employ an automatic repeat request (ARQ) protocol to provide reliable data packet communications with the wireless user equipment and to determine whether the signal quality of the uplink channel is sufficient for the base station to accurately receive an ARQ feedback signal from the wireless user equipment.

43. The mobile communications system in claim 42, wherein the sufficiency of the signal quality of uplink channel is determined so that a probability of error in the received ARQ feedback signal is below a threshold.

44. The mobile communications system in claim 42, wherein the feedback signal is an acknowledge (ACK) signal, a negative acknowledge (NACK) signal, or a lost signal corresponding to a data packet transmitted over the downlink channel.

45. The mobile communications system in claim 42, wherein the scheduler is configured to delay transmission of data packets over the downlink channel until the quality of the uplink channel exceeds a predetermined threshold.

46. The mobile communications system in claim 45, wherein the base station is configured to transit the data packets after a preset delay period expires.

47. The mobile communications system in claim 39, wherein the wireless user equipment is communicating with two base stations in a soft handover communication.

48. The mobile communications system in claim 39, the base station further including:
a third detector configured to detect a predetermined condition, wherein the schedule is configured to schedule the downlink data packet transmission without regard to the uplink channel signal quality when the predetermined condition is detected.

49. The mobile communications system in claim 48, wherein the detected condition is when a doppler frequency of the uplink channel exceeds a threshold.

50. The mobile communications system in claim 48, wherein the detected condition is when a load of a cell corresponding to the base station is less than a threshold.
